(19) United States
(12) Patent Application Publication
(10) Pub. No.: US 2010/0105380 A1
(43) Pub. Date: Apr. 29, 2010

(54) METHOD AND APPARATUS FOR BROADCASTING SYSTEM INFORMATION IN A WIRELESS COMMUNICATION NETWORK

(75) Inventors: Rashid Ahmed Akbar Attar, San Diego, CA (US); Nathan Edward Tenny, Poway, CA (US); Masato Kitazoe, Tokyo (JP)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/259,501

(22) Filed: Oct. 28, 2008

(51) Int. Cl. H04W 4/00

(52) U.S. Cl. 455/434

(57) ABSTRACT

Techniques for broadcasting system information in a wireless communication network are described. A cell may support one or more public land mobile networks (PLMNs). The cell may send a PLMN table in a first message on a broadcast channel and may send at least one index to the PLMN table in a second message on the broadcast channel. The PLMN table may include entries for different possible PLMNs or different possible combinations of PLMNs. A UE may receive the first message from a serving cell and may receive the second message from a candidate cell for cell reselection. The UE may obtain the PLMN table from the first message and may obtain at least one index to the PLMN table from the second message. The UE may determine whether the second cell is accessible by the UE based on the PLMN table and the at least one index.

### BACKGROUND

I. Field

The present disclosure relates generally to communication, and more specifically to techniques for broadcasting system information in a wireless communication network.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of Node Bs that can support communication for a number of user equipments (UEs). Each Node B may support one or more cells, where the term “cell” can refer to a coverage area of a Node B and/or a Node B subsystem serving the coverage area. Each cell may broadcast system information to support operation by the UEs. Much resources may be consumed to broadcast the system information such that it can be reliably received by the UEs. There is therefore a need in the art for techniques to efficiently broadcast system information.

### SUMMARY

Techniques for broadcasting system information in a wireless communication network are described herein. A cell may support one or more public land mobile networks (PLMNs). The cell may broadcast a list of PLMN identifiers (IDs) of the PLMNs supported by the cell in order to allow UEs to determine whether the cell is accessible by the UEs. Many bits and much resources may be used to explicitly broadcast the list of PLMN IDs to the UEs.

In an aspect, a cell may send a PLMN table in a first message on a broadcast channel, e.g., to UEs within the cell. The PLMN table may include entries for different possible PLMNs or different possible combinations of PLMNs. The cell may also send at least one index to the PLMN table in a second message on the broadcast channel, e.g., to UEs in the cell as well as UEs in neighbor cells. The PLMN table and the at least one index may be sent in different System Information Blocks (SIBs), different system information (SI) messages, etc. The PLMN table and the at least one index may be used to determine a list of PLMNs supported by the cell. The at least one index may be sent using much fewer bits than a list of PLMN IDs, which may save resources.

In one design, a UE may receive the first message on the broadcast channel from a first cell, e.g., a serving cell for the UE. The UE may also receive the second message on the broadcast channel from a second cell, e.g., a candidate cell for cell reselection by the UE. The UE may obtain the PLMN table from the first message and may also obtain at least one index to the PLMN table from the second message. The UE may determine whether the second cell is accessible by the UE based on the PLMN table and the at least one index. For example, the UE may determine at least one PLMN supported by the second cell based on the PLMN table and the at least one index. The UE may then determine that the second cell is accessible by the UE if any PLMN permitted for the UE matches any PLMN supported by the second cell.

The techniques may be used to send a table of other information instead of PLMN IDs. Various aspects and features of the disclosure are described in further detail below.

### BRIEF DESCRIPTION OF THE DRAWINGS

FIG. 1 shows a wireless communication network.

FIG. 2 shows transmission of system information by a cell.

FIG. 3 shows transmission of a PLMN table and a profile index.

FIG. 4 shows transmission of a PLMN table and at least one PLMN index.

FIG. 5 shows transmission of a PLMN table and at least one index with different coverage.

FIG. 6 shows cell selection and cell reselection by a UE.

FIG. 7 shows a process for performing cell reselection by a UE.

FIG. 8 shows an apparatus for performing cell reselection.

FIG. 9 shows a process for supporting cell reselection by a cell.

FIG. 10 shows an apparatus for supporting cell reselection.

FIG. 11 shows a block diagram of a Node B and a UE.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). cdma2000 and UMB are described in documents from an organization named “3rd Generation Partnership Project 2” (3GPP2). For clarity, certain aspects of the techniques are described below for LTE, and LTE terminology is used in much of the description below.

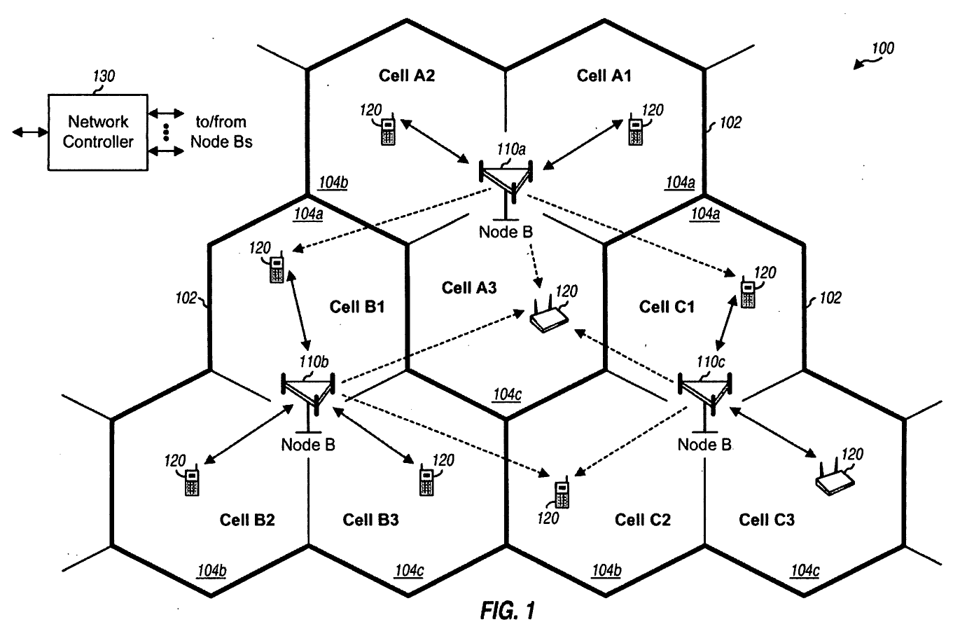

FIG. 1 shows a wireless communication network 100, which may be an LTE network. Network 100 may include a number of Node Bs and other network entities. For simplicity, only three Node Bs 110a, 110b and 110c and one network controller 130 are shown in FIG. 1. A Node B may be a fixed station used for communicating with the UEs and may also be referred to as an evolved Node B (eNB), a base station, an access point, etc. Each Node B 110 provides communication coverage for a particular geographic area 102. To improve network capacity, the overall coverage area of a Node B may be partitioned into multiple smaller areas, e.g., three smaller areas 104a, 104b and 104c. Each smaller area may be served by a respective Node B subsystem. In 3GPP, the term “cell” can refer to the smallest coverage area of a Node B and/or a Node B subsystem serving this coverage area.

In the example shown in FIG. 1, each Node B 110 has three cells that cover different geographic areas. For simplicity, FIG. 1 shows the cells not overlapping one another. In a practical deployment, adjacent cells typically overlap one another at the edges, which may allow a UE to receive communication coverage from one or more cells at any location as the UE moves about the network.

UEs 120 may be dispersed throughout the network, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, etc. A UE may communicate with a Node B via the downlink and uplink. The downlink (or forward link) refers to the communication link from the Node B to the UE, and the uplink (or reverse link) refers to the communication link from the UE to the Node B. In FIG. 1, a solid line with double arrows indicates bi-directional communication between a Node B and a UE. A dashed line with a single arrow indicates a UE receiving a downlink signal from a Node B. e.g., for system information.

Wireless network 100 may be part of a PLMN. A PLMN may comprise an LTE network, a UMTS network, a GSM network, etc. A PLMN may be uniquely identified by a 24-bit PLMN ID composed of a Mobile Country Code (MCC) and a Mobile Network Code (MNC). Multiple PLMNs may be deployed by different network operators/service providers in a given geographic area. These network operators may have roaming agreements. A UE that has a service subscription with one network operator (a home network operator) may be able to communicate with PLMNs operated by the home network operator as well as PLMNs operated by other network operators having roaming agreements with the home network operator. The UE may maintain a PLMN list containing permitted PLMNs from which the UE can receive service. The PLMN list may be provisioned on the UE by the home network operator.

The overall coverage area of a wireless network may be partitioned into tracking areas. Each tracking area may include a group of cells located near each other. In one design, the tracking areas may be non-overlapping, and each cell may belong in one tracking area. In another design, the tracking areas may overlap, and a cell may belong in multiple tracking areas. In any case, whenever a UE moves into a new tracking area, the UE may exchange signaling messages with the network in order to update its tracking area. If an incoming call is thereafter received for the UE, then a paging message may be sent to the UE by all cells in the current tracking area of the UE. By updating the tracking area of the UE as necessary, the UE can be reached by the network whenever needed.

In LTE, data and system information are processed as logical channels at a Radio Link Control (RLC) layer. The logical channels are mapped to transport channels at a Medium Access Control (MAC) layer. The transport channels are mapped to physical channels at a physical layer (PHY). Table 1 lists some logical, traffic, and physical channels that may be used to send system information and provides a short description of each channel.

TABLE 1

| Channel | Name | Type | Description |
|---|---|---|---|
| Broadcast Control | BCCH | Logical | Carry system information. |
| Channel | | Channel | |
| Broadcast Channel | BCH | Transport | Carry the most essential |
| | | Channel | part of the system |
| | | | information. |
| Downlink Shared | DL-SCH | Transport | Carry the remaining part |
| Channel | | Channel | of the system information. |
| Physical Broadcast | PBCH | Physical | Carry the BCH. |
| Channel | | Channel | |
| Physical Downlink | PDSCH | Physical | Carry the DL-SCH. |
| Shared Channel | | Channel | |

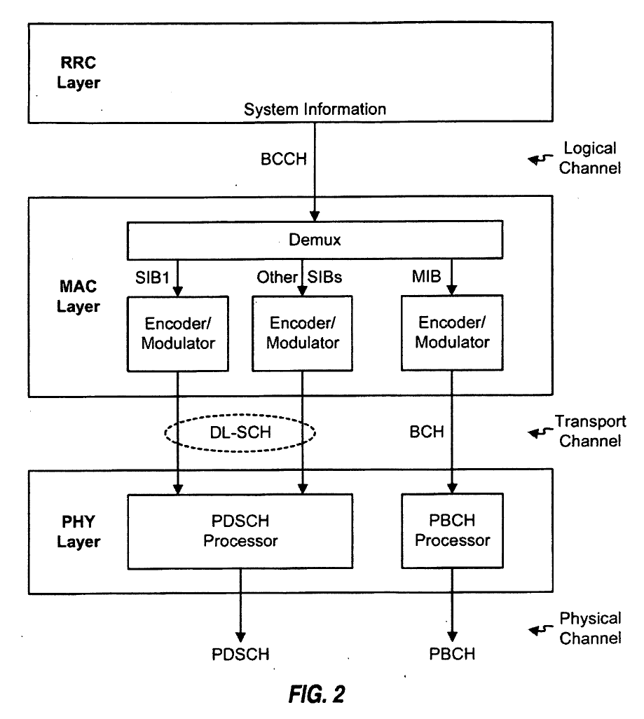

FIG. 2 shows a design of transmission of system information by a cell using the logical, traffic, and physical channels shown in Table 1. A Radio Resource Control (RRC) layer may provide system information on the BCCH. The system information may be divided into a Master Information Block (MIB) and System Information Blocks (SIBs). The MIB may carry a limited number of the most essential and frequently transmitted parameters of the system information. The MIB may be sent on the BCH to UEs in the cell as well as UEs in neighbor cells. The MIB may be processed at the MAC layer and the physical layer and may be mapped to the PBCH.

The SIBs may include System Information Block Type1 (SIB1) as well as other SIBs. SIB1 may include (i) relevant information used to determine whether a UE is allowed to access a cell and (ii) scheduling information for other SIBs. SIB1 may be sent on the DL-SCH at a predetermined periodicity, e.g., every 80 milliseconds (ms). The other SIBs may carry the remainder of the system information. Each SIB may carry a specific set of parameters and may be sent at a suitable periodicity indicated by the scheduling information in SIB1. SIB1 may be sent on the DL-SCH to the UEs in the cell as well as the UEs in neighbor cells. SIB1 may thus have characteristics similar to those of the MIB. The other SIBs may also be sent on the DL-SCH to the UEs in the cell and possibly the UEs in the neighbor cells. The SIBs may be processed at the MAC layer and the physical layer and may be mapped to the PDSCH.

A cell may broadcast various parameters in the system information. One such parameter is a list of one or more PLMN IDs of one or more PLMNs supported by the cell. The PLMN ID information may be used by the UEs to determine whether they can access the cell. For example, the cell may be accessible by a UE if one of the PLMN ID(s) broadcast by the cell matches one of the permitted PLMN(s) stored at the UE. The cell may be operated by a single network operator and may broadcast one or more PLMN IDs of one or more PLMNs belonging to the network operator. The cell may also be shared by multiple network operators, which may share the same Node B hardware and cell site. In such a network sharing scenario, the cell may broadcast the PLMN IDs of all PLMNs of all network operators sharing the cell.

In one design, the cell may broadcast up to six PLMN IDs in SIB1 for a network sharing scenario. If the maximum number of PLMN IDs is sent in SIB1, then a relatively large block of data may need to be transmitted for SIB1. SIB1 may be sent to UEs in neighbor cells. Hence, a large amount of resources may be consumed to transmit all PLMN IDs in SIB1 to the UEs in the neighbor cells.

In an aspect, a PLMN table containing entries for different possible PLMN IDs or different possible combinations of PLMN IDs may be sent in a designated SIB, which may be referred to as SIBx. At least one index to the PLMN table may be sent in another SIB, which may be SIB1. The PLMN table and the at least one index may be used to determine a list of PLMNs supported by a cell. The PLMN table may be sent to UEs in the cell. The at least one index may be sent to UEs in the neighbor cells and may be sent using much fewer bits than the list of PLMN IDs. This may reduce the amount of resources needed to send PLMN ID information to the UEs. The PLMN table and the at least one index may be sent in various manners, as described below.

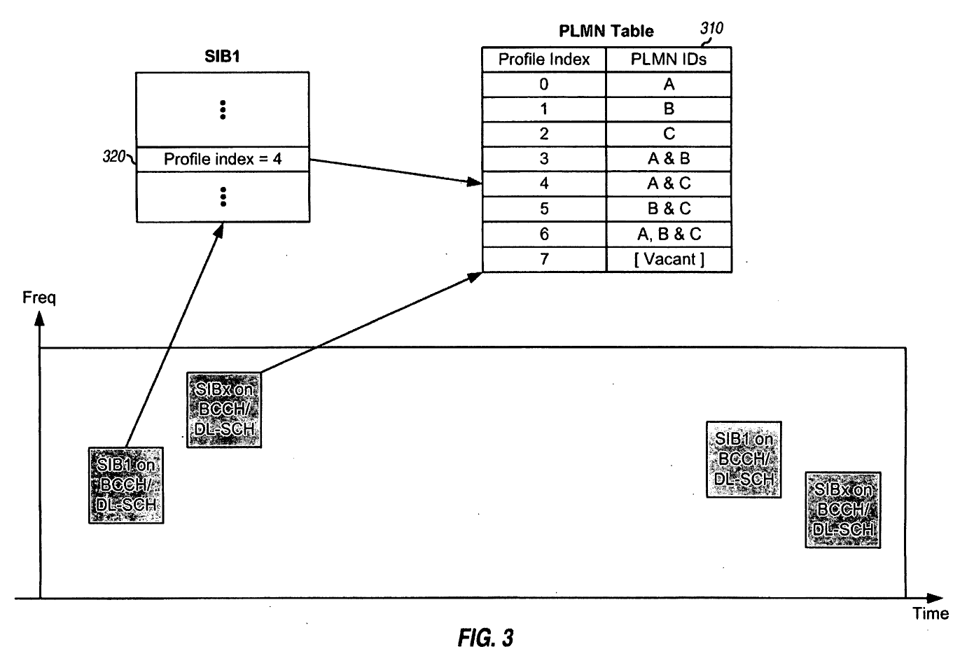

FIG. 3 shows a design of transmission of a PLMN table 310 and a profile index 320 for a list of PLMNs supported by a cell. In this design, PLMN table 310 may include one entry for each possible combination of one or more PLMNs supported by a cell. In the example shown in FIG. 3, there are three possible PLMN IDs of A, B and C, and PLMN table 310 includes seven entries for different network sharing profiles. The first three entries are for one PLMN ID of A, B and C. The next three entries are for three possible combinations of two PLMN IDs. The next entry is for one possible combination of three PLMN IDs. The seven entries are assigned profile indices of 0 through 6, respectively. Each profile index may be conveyed with three bits, with profile index 7 being vacant and not used. PLMN table 310 may be sent in SIBx on the BCCH/DL-SCH.

A list of PLMN IDs for a cell may be given by a profile index for an entry in PLMN table 310. The profile index may also be referred to as a profile ID. In the example shown in FIG. 3, the PLMN list for the cell includes PLMN IDs A and C and may be conveyed by profile index 4. The cell may send profile index 4 in SIB1 on the BCCH/DL-SCH.

In the design shown in FIG. 3, a single 3-bit profile index can convey any combination of up to three PLMN IDs for a cell. To send three full PLMN IDs for a cell supporting all three PLMNs would take 72 bits. Substantially fewer bits may thus be sent in SIB1 using the design shown in FIG. 3.

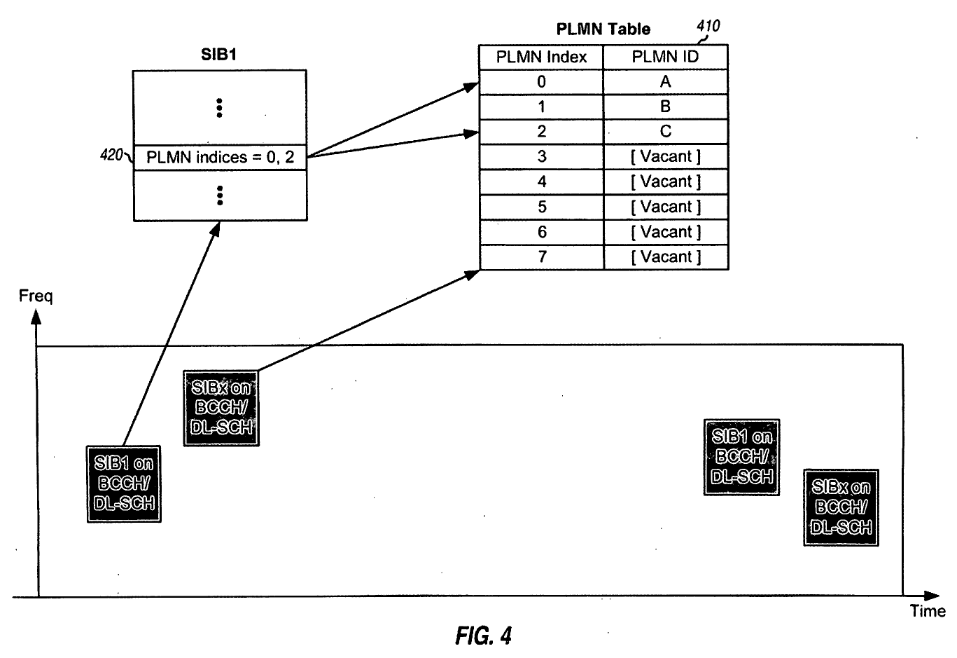

FIG. 4 shows a design of transmission of a PLMN table 410 and at least one PLMN index 420 for a list of PLMNs supported by a cell. In this design, a PLMN table 410 may include one entry for each possible PLMN that might be supported by a cell. In the example shown in FIG. 4, there are three possible PLMN IDs of A, B and C. PLMN table 410 includes one entry for PLMN ID A, another entry for PLMN ID B, and a third entry for PLMN ID C. In one design that is not shown in FIG. 4, the three entries are assigned PLMN indices of 0 through 2, and each PLMN index may be conveyed with two bits. In another design that is shown in FIG. 4, additional entries may be defined to carry up to six PLMN IDs and may be left vacant if not used. In this design, each PLMN index may be conveyed with three bits. PLMN table 410 may be sent in SIBx on the BCCH/DL-SCH.

A list of PLMN IDs for a cell may be given by one or more PLMN indices for one or more entries in PLMN table 410. In the example shown in FIG. 4, the PLMN list for the cell includes PLMN IDs A and C and may be conveyed by PLMN indices 0 and 2. The cell may send PLMN indices 0 and 2 in SIB1 on the BCCH/DL-SCH.

In the design shown in FIG. 4, up to three 3-bit PLMN indices can convey up to three PLMN IDs for a cell. To send three full PLMN IDs would take 72 bits. Substantially fewer bits may thus be sent in SIB1 using the design shown in FIG. 4.

In general, a PLMN table may be applicable for a geographic area of any size, e.g., a tracking area, a city, a state, an entire country, etc. Even in the most complex network sharing scenarios, there may be relatively few PLMNs in a given geographic area, and relatively few combinations may be valid network sharing configurations. A PLMN table for all PLMNs operating in the geographic area may be defined, e.g., using the format shown in FIG. 3 or 4. A list of PLMN IDs for a given cell may then be described more compactly by one or more indices into the PLMN table instead of explicitly listing all of the PLMN IDs. Network sharing may be more efficiently supported by using the PLMN table and one or more indices.

FIGS. 3 and 4 show two designs of sending a PLMN table and at least one index to convey one or more supported PLMNs. The PLMN table and the at least one index may also be sent in other manners. The PLMN table may include all PLMNs or all combinations of PLMNs. Alternatively, the PLMN table may exclude unused combinations of PLMNs for network operators known not to have network sharing arrangements.

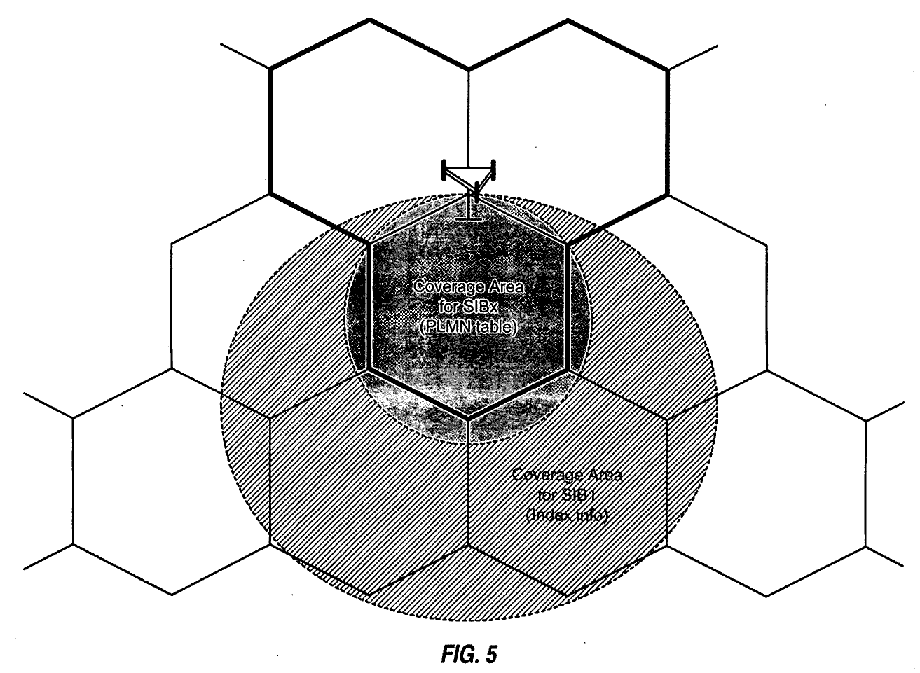

FIG. 5 shows a design of transmitting SIB1 carrying at least one index and SIBx carrying a PLMN table. A cell may process (e.g., encode and modulate) the PLMN table and other information for SIBx such that they can be reliably received by UEs in the cell. The limited coverage for SIBx may result in less resources being used to send SIBx. The cell may process the at least one index and other information for SIB1 such that they can be reliably received by UEs in neighbor cells. The limited amount of information sent in SIB1 may result in less resources being used to send SIB 1.

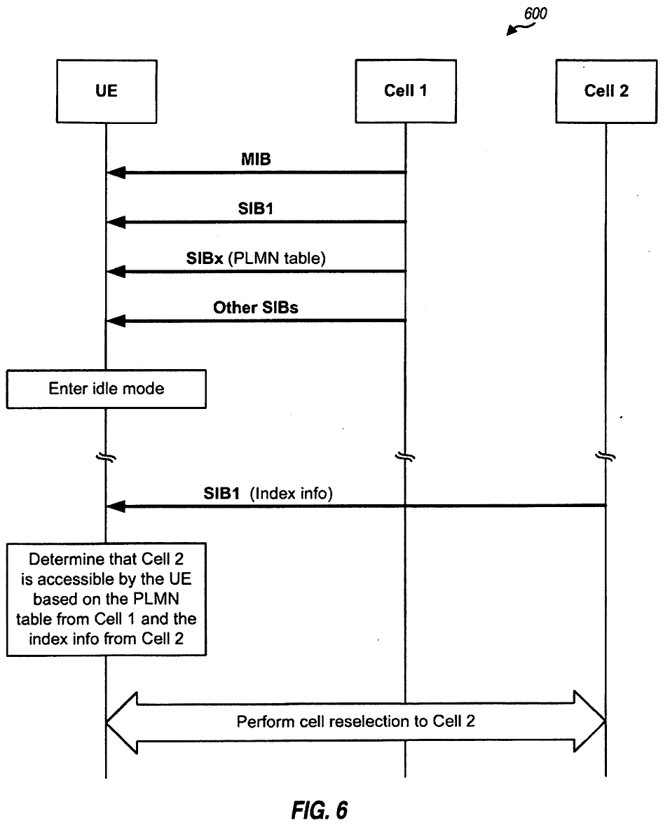

FIG. 6 shows a design of a process 600 for performing cell selection and cell reselection by a UE. The UE may arrive for the first time on the network and may not have knowledge of the system information. The UE may detect cell 1 and may receive the MIB from cell 1 to obtain pertinent system parameters. The UE may then receive SIB1 from cell 1 and obtain scheduling information for other SIBs. The UE may then receive SIBx and other SIBs based on the scheduling information. The UE may obtain a PLMN table (e.g., as shown in FIG. 3 or 4) from SIBx and may determine that cell 1 belongs in a PLMN that is permitted for the UE. The UE may select cell 1 as a serving cell via a process referred to as cell selection. The UE may enter an idle mode and camp on cell 1 if the UE has no data to send or receive.

While camped on serving cell 1 in the idle mode, the UE may periodically search for better cells, e.g., cells with stronger received signal strength. In the example shown in FIG. 6, the UE detects cell 2 as being better than serving cell 1. The UE may then receive SIB1 from cell 2 and obtain at least one index (e.g., a profile index or one or more PLMN indices) from SIB1. The UE may assume that cells 1 and 2 use the same PLMN table. The UE may then apply the at least one index obtained from cell 2 to the PLMN table obtained from cell 1 to determine a list of PLMN IDs for cell 2. The UE may then determine whether cell 2 supports a permitted PLMN for the UE based on the list of PLMN IDs for cell 2 and the list of permitted PLMNs stored at the UE. If cell 2 supports a permitted PLMN and is accessible by the UE, then the UE may select cell 2 as a new serving cell via a process referred to as cell reselection.

In general, the UE may obtain a PLMN table from one cell and may use this PLMN table for any other cell using the same table. The UE can determine which PLMN table (or which version of the PLMN table) a given cell uses in several manners. In one design, a PLMN table may be assigned a table ID. If neighbor cells use different PLMN tables, then these PLMN tables may be assigned different table IDs to allow the UEs to distinguish between these tables. Each cell may send a table ID for its PLMN table along with the at least one index in SIB1. For the example shown in FIG. 6, the UE may be able to determine whether the PLMN table obtained from cell 1 is applicable for cell 2 based on the table ID received from cell 1 in SIBx and the table ID received from cell 2 in SIB1. Some bits may be used to send the table ID in SIB1. However, the total number of bits used for the table ID and the at least one index should still be less than the number of bits for a single PLMN and should be far less than the total number of bits for several PLMNs, if they are explicitly sent.

In another design, a PLMN table may be applicable for a tracking area and may be associated with a tracking area ID, which may be conveyed in SIB1. For the example shown in FIG. 6, the UE may obtain the tracking area ID for cell 2 from SIB 1 and may use the PLMN table obtained from cell 1 if both cells 1 and 2 belong in the same tracking area. If the UE moves between tracking areas and cell 2 belongs in a different tracking area, then the UE may first receive SIBx from cell 2 to obtain the PLMN table for this tracking area. The UE may then determine whether cell 2 is accessible based on the at least one index obtained from SIB1 and the PLMN table obtained from SIBx of cell 2. A cell at the edge of a tracking area (e.g., cell 1) may broadcast PLMN tables for neighboring tracking areas. This may allow the UE to obtain a PLMN table for a cell in another tracking area (e.g., cell 2) from the current serving cell.

In general, a table ID may be specifically defined for a PLMN table or may be based on another ID, e.g., a tracking area ID. A table ID would only need to be locally unique so that it can inform a UE to read a new PLMN table when its mobility takes it outside the scope of an old PLMN table. If two areas use different PLMN tables with the same table ID, then ambiguity may arise only if a UE can enter one area while still remembering the PLMN table from the other area. It may be undesirable for the UE to have too long a memory for a PLMN table, since the PLMN table could have changed even if the UE returns to a previously visited area. The UE may have a short-term memory for PLMN tables for visited areas, so that the UE can avoid reading SIBx every time the UE moves between two cells with different PLMN tables. A synchronization mechanism such as value tags for PLMN tables may be used to ensure that the UE does not miss a change to a PLMN table while absent from an area.

In one design, SIB1 may include the following information:
A PLMN table, e.g., as shown in FIG. 3 or 4,
A tracking area ID for a cell, and
Barring information indicating whether a cell is barred from access by UEs.

SIB1 may also include different and/or additional information. The barring information may indicate whether the cell is barred from use, e.g., reserved for network operator use. The PLMN table, the tracking area ID, and the barring information may be used to determine whether the cell is accessible by a UE.

The techniques described herein may allow a cell to send a limited amount of information in SIB1. This may be desirable in order to conserve resources, especially since SIB1 may be sent to UEs in neighbor cells. The techniques may be advantageous in network sharing scenarios in which sending multiple PLMN IDs individually in SIB1 may consume too much resources.

In general, a PLMN table and at least one index may be sent in any two messages or any two SIBs on a broadcast channel (e.g., the BCCH). For clarity, much of the description above assumes transmission of the PLMN table and the at least one index in SIBx and SIB1, respectively. The PLMN table and the at least one index may also be sent in other SIBs, in system information (SI) messages, etc.

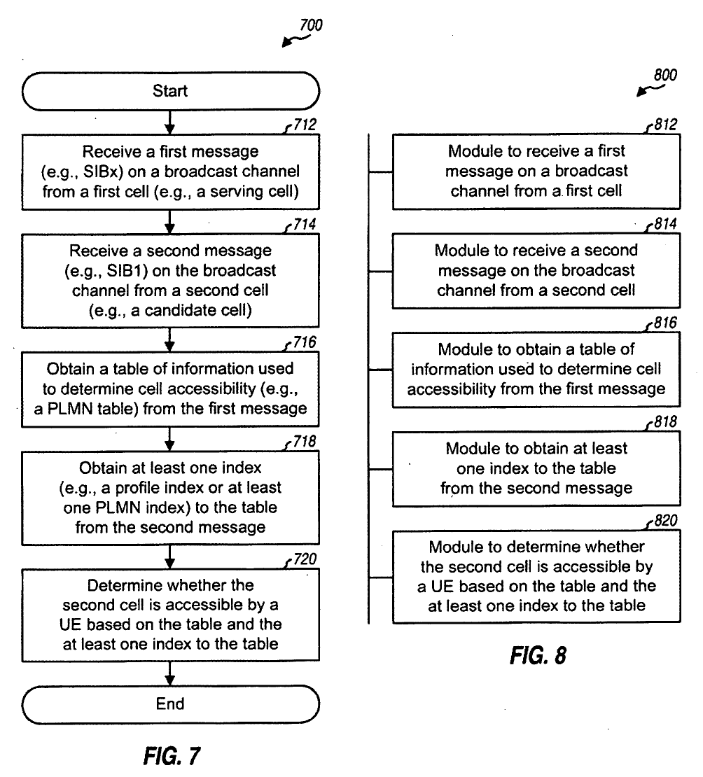

FIG. 7 shows a design of a process 700 for performing cell reselection by a UE. The UE may receive a first message on a broadcast channel from a first cell (block 712). The UE may also receive a second message on the broadcast channel from a second cell (block 714). The UE may receive the broadcast channel (e.g., the BCCH) on a downlink shared channel (e.g., the DL-SCH) sent by the first and second cells. The UE may obtain a table of information used to determine cell accessibility from the first message (block 716). The UE may obtain at least one index to the table from the second message (block 718). The UE may determine whether the second cell is accessible by the UE based on the table and the at least one index to the table (block 720). In one design, the first cell may be a serving cell for the UE, which may be operating in an idle mode. The second cell may be a candidate cell for cell reselection by the UE. In another design, the first and the second cells may both be a candidate cell for cell reselection by the UE.

In one design of blocks 712 and 714, the UE may obtain a PLMN table from the first message and may obtain at least one index to the PLMN table from the second message. In one design, the PLMN table may comprise multiple entries, with each entry being for a different combination of at least one PLMN and associated with a unique profile index, e.g., as shown in FIG. 3. The at least one index may then comprise a profile index for an entry in the PLMN table. In another design, the PLMN table may comprise multiple entries, with each entry being for a different PLMN and associated with a unique PLMN index, e.g., as shown in FIG. 4. The at least one index may then comprise at least one PLMN index for at least one entry in the PLMN table. For both designs, the UE may determine at least one PLMN supported by the second cell based on the PLMN table and the at least one index. The UE may then determine whether the second cell is accessible by the UE based on the at least one PLMN supported by the second cell and at least one PLMN permitted for the UE.

The UE may determine whether the PLMN table obtained from the first cell is applicable for the second cell in various manners. In one design, the UE may obtain a first table ID for the PLMN table from the first message and may also obtain a second table ID from the second message. The UE may then determine that the PLMN table obtained from the first cell is applicable for the second cell if the first table ID matches the second table ID. In another design, the UE may obtain a first tracking area ID for the first cell and may also obtain a second tracking area ID for the second cell. The UE may then determine that the PLMN table obtained from the first cell is applicable for the second cell if the first tracking area ID matches the second tracking area ID.

If the UE determines that the PLMN table is not applicable for the second cell, then the UE may receive a third message on the broadcast channel from the second cell and may obtain a second PLMN table from the third message. The UE may then determine at least one PLMN supported by the second cell based on the second PLMN table and the at least one index received from the second cell.

The UE may also determine whether the second cell is barred based on the second message. The UE may determine that the second cell is inaccessible by the UE if it is barred.

In one design, the first message may be sent by the first cell to UEs in the first cell and possibly to UEs in neighbor cells. The second message may be sent by the second cell to UEs in the second cell as well as UEs in neighbor cells. In one design, the first message may comprise a SIB carrying the table. The second message may comprise a SIB1 carrying the at least one index to the table.

FIG. 8 shows a design of an apparatus 800 for performing cell reselection. Apparatus 800 includes a module 812 to receive a first message (e.g., SIBx) on a broadcast channel from a first cell, a module 814 to receive a second message (e.g., SIB1) on the broadcast channel from a second cell, a module 816 to obtain a table of information used to determine cell accessibility (e.g., a PLMN table) from the first message, a module 818 to obtain at least one index (e.g., a profile index or at least one PLMN index) to the table from the second message, and a module 820 to determine whether the second cell is accessible by a UE based on the table and the at least one index to the table.

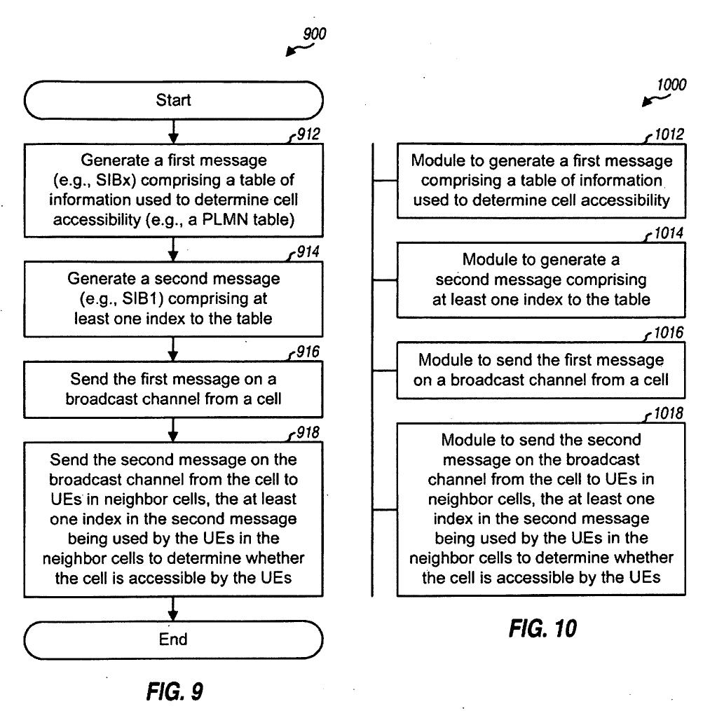

FIG. 9 shows a design of a process 900 for supporting cell reselection by a cell. The cell may generate a first message comprising a table of information used to determine cell accessibility (block 912). The cell may also generate a second message comprising at least one index to the table (block 914). The cell may send the first message on a broadcast channel (block 916). The cell may also send the second message on the broadcast channel to UEs in neighbor cells (block 918). The at least one index in the second message may be used by the UEs in the neighbor cells to determine whether the cell is accessible by the UEs.

In one design, the first message may comprise a PLMN table having multiple entries, with each entry being for a different combination of at least one PLMN and associated with a unique profile index. The second message may comprise a profile index for an entry in the PLMN table. In another design, the first message may comprise a PLMN table having multiple entries, with each entry being for a different PLMN and associated with a unique PLMN index. The second message may comprise at least one PLMN index for at least one entry in the PLMN table.

FIG. 10 shows a design of an apparatus 1000 for supporting cell reselection. Apparatus 1000 includes a module 1012 to generate a first message comprising a table of information used to determine cell accessibility, a module 1014 to generate a second message comprising at least one index to the table, a module 1016 to send the first message on a broadcast channel from a cell, and a module 1018 to send the second message on the broadcast channel from the cell to UEs in neighbor cells, with the at least one index in the second message being used by the UEs in the neighbor cells to determine whether the cell is accessible by the UEs.

The modules in FIGS. 8 and 10 may comprise processors, electronics devices, hardware devices, electronics components, logical circuits, memories, etc., or any combination thereof.

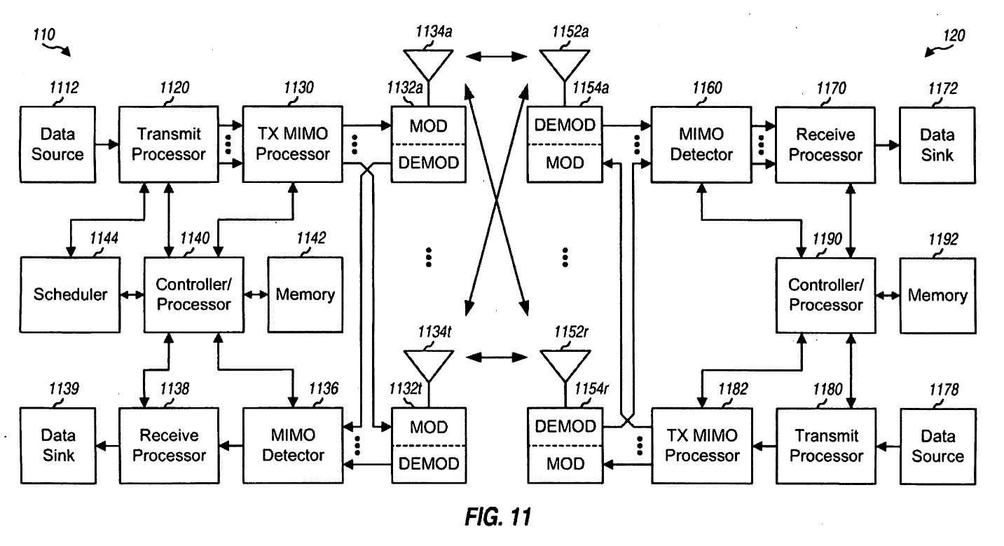

FIG. 11 shows a block diagram of a design of Node B 110 and UE 120, which may be one of the Node Bs and one of the UEs in FIG. 1. In this design, Node B 110 is equipped with T antennas 1134a through 1134t, and UE 120 is equipped with R antennas 1152a through 1152r, where in general T≧1 and R≧1.

At Node B 110, a transmit processor 1120 may receive traffic data for UEs from a data source 1112, process the traffic data for each UE, and provide data symbols for all UEs. Transmit processor 1120 may also receive system information and control information from a controller/processor 1140 and/or a scheduler 1144. Transmit processor 1120 may process the system and control information and provide overhead symbols. A transmit (TX) multiple-input multiple-output (MIMO) processor 1130 may multiplex the data symbols and the overhead symbols with pilot symbols, process (e.g., precode) the multiplexed symbols, and provide T output symbol streams to T modulators (MOD) 1132a through 1132t. Each modulator 1132 may process a respective output symbol stream (e.g., for OFDM) to obtain an output sample stream. Each modulator 1132 may further process (e.g., convert to analog, amplify, filter, and upconvert) the output sample stream to obtain a downlink signal. T downlink signals from modulators 1132a through 1132t may be transmitted via T antennas 1134a through 1134t, respectively.

At UE 120, antennas 1152a through 1152r may receive the downlink signals from Node B 110 and provide received signals to demodulators (DEMOD) 1154a through 1154r, respectively. Each demodulator 1154 may condition (e.g., filter, amplify, downconvert, and digitize) a respective received signal to obtain received samples and may further process the received samples (e.g., for OFDM) to obtain received symbols. A MIMO detector 1160 may receive and process the received symbols from all R demodulators 1154a through 1154r and provide detected symbols. A receive processor 1170 may process the detected symbols, provide decoded traffic data for UE 120 to a data sink 1172, and provide decoded system and control information to a controller/processor 1190.

On the uplink, at UE 120, traffic data from a data source 1178 and control information from controller/processor 1190 may be processed by a transmit processor 1180, precoded by a TX MIMO processor 1182 (if applicable), conditioned by modulators 1154a through 1154r, and transmitted via antennas 1152a through 1152r. At Node B 110, the uplink signals from UE 120 may be received by antennas 1134, conditioned by demodulators 1132, detected by a MIMO detector 1136, and processed by a receive processor 1138 to obtain the traffic data and control information transmitted by UE 120.

Controllers/processors 1140 and 1190 may direct the operation at Node B 110 and UE 120, respectively. Controller/processor 1140 at Node B 110 may implement or direct process 900 in FIG. 9 and/or other processes for the techniques described herein. Controller/processor 1190 at UE 120 may implement or direct process 700 in FIG. 7 and/or other processes for the techniques described herein. Controller/processor 1190 may also direct the operation of the UE in FIG. 6. Memories 1142 and 1192 may store data and program codes for Node B 110 and UE 120, respectively. Scheduler 1144 may schedule UEs for downlink and/or uplink transmission.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
receiving a first message on a broadcast channel from a first cell;
receiving a second message on the broadcast channel from a second cell;
obtaining a table of information used to determine cell accessibility from the first message;
obtaining at least one index to the table from the second message; and
determining whether the second cell is accessible by a user equipment (UE) based on the table and the at least one index to the table.

2. The method of claim 1, further comprising:
receiving the broadcast channel on a downlink shared channel from the first and second cells.

3. The method of claim 1, wherein the obtaining a table comprises obtaining a public land mobile network (PLMN) table from the first message, and wherein the determining whether the second cell is accessible by the UE comprises
determining at least one PLMN supported by the second cell based on the PLMN table and the at least one index, and
determining whether the second cell is accessible by the UE based on the at least one PLMN supported by the second cell and at least one PLMN permitted for the UE.

4. The method of claim 3, wherein the PLMN table comprises multiple entries, each entry being for a different combination of at least one PLMN and associated with a unique profile index, and wherein the at least one index obtained from the second message comprises a profile index for an entry in the PLMN table.

5. The method of claim 3, wherein the PLMN table comprises multiple entries, each entry being for a different PLMN and associated with a unique PLMN index, and wherein the at least one index obtained from the second message comprises at least one PLMN index for at least one entry in the PLMN table.

6. The method of claim 3, wherein the first and second cells are both a candidate cell for cell reselection by the UE, the method further comprising:
receiving a third message on the broadcast channel from a serving cell for the UE; and
obtaining a second PLMN table from the third message, and wherein the first message is received from the candidate cell upon determining that the second PLMN table obtained from the serving cell is not applicable for the candidate cell.

7. The method of claim 3, further comprising:
obtaining a first table identifier (ID) for the PLMN table from the first message;
obtaining a second table ID from the second message; and
determining that the PLMN table obtained from the first cell is applicable for the second cell if the first table ID matches the second table ID.

8. The method of claim 3, further comprising:
obtaining a first tracking area identifier (ID) for the first cell;
obtaining a second tracking area ID for the second cell; and
determining that the PLMN table obtained from the first cell is applicable for the second cell if the first tracking area ID matches the second tracking area ID.

9. The method of claim 1, wherein the determining whether the second cell is accessible by the UE comprises
determining whether the second cell is barred based on the second message, and
determining that the second cell is inaccessible by the UE if barred.

10. The method of claim 1, wherein the first cell is a serving cell for the UE, and wherein the second cell is a candidate cell for cell reselection by the UE.

11. The method of claim 1, wherein the first and second cells are both a candidate cell for cell reselection by the UE.

12. The method of claim 1, wherein the first message is sent by the first cell to UEs in the first cell, and wherein the second message is sent by the second cell to UEs in neighbor cells including the first cell.

13. The method of claim 1, wherein the first message comprises a System Information Block (SIB) carrying the table, and wherein the second message comprises a System Information Block Type 1 (SIB1) carrying the at least one index to the table.

14. An apparatus for wireless communication, comprising:
at least one processor configured to receive a first message on a broadcast channel from a first cell, to receive a second message on the broadcast channel from a second cell, to obtain a table of information used to determine cell accessibility from the first message, to obtain at least one index to the table from the second message, and to determine whether the second cell is accessible by a user equipment (UE) based on the table and the at least one index to the table.

15. The apparatus of claim 14, wherein the at least one processor is configured to obtain from the first message a public land mobile network (PLMN) table comprising multiple entries, each entry being for a different combination of at least one PLMN and associated with a unique profile index, to obtain a profile index for an entry in the PLMN table from the second message, to determine at least one PLMN supported by the second cell based on the PLMN table and the profile index, and to determine whether the second cell is accessible by the UE based on the at least one PLMN supported by the second cell and at least one PLMN permitted for the UE.

16. The apparatus of claim 14, wherein the at least one processor is configured to obtain from the first message a public land mobile network (PLMN) table comprising multiple entries, each entry being for a different PLMN and associated with a unique PLMN index, to obtain at least one PLMN index for at least one entry in the PLMN table from the second message, to determine at least one PLMN supported by the second cell based on the PLMN table and the at least one PLMN index, and to determine whether the second cell is accessible by the UE based on the at least one PLMN supported by the second cell and at least one PLMN permitted for the UE.

17. The apparatus of claim 14, wherein the at least one processor is configured to obtain the table from a System Information Block (SIB) in the first message, and to obtain the at least one index to the table from a System Information Block Type 1 (SIB1) in the second message.

18. An apparatus for wireless communication, comprising:
means for receiving a first message on a broadcast channel from a first cell;
means for receiving a second message on the broadcast channel from a second cell;
means for obtaining a table of information used to determine cell accessibility from the first message;
means for obtaining at least one index to the table from the second message; and
means for determining whether the second cell is accessible by a user equipment (UE) based on the table and the at least one index to the table.

19. The apparatus of claim 18, wherein the means for obtaining a table comprises means for obtaining from the first message a public land mobile network (PLMN) table comprising multiple entries, each entry being for a different combination of at least one PLMN and associated with a unique profile index, wherein the means for obtaining at least one index to the table comprises means for obtaining a profile index for an entry in the PLMN table from the second message, and wherein the means for determining whether the second cell is accessible by the UE comprises
means for determining at least one PLMN supported by the second cell based on the PLMN table and the profile index, and
means for determining whether the second cell is accessible by the UE based on the at least one PLMN supported by the second cell and at least one PLMN permitted for the UE.

20. The apparatus of claim 18, wherein the means for obtaining a table comprises means for obtaining from the first message a public land mobile network (PLMN) table comprising multiple entries, each entry being for a different PLMN and associated with a unique PLMN index, wherein the means for obtaining at least one index to the table comprises means for obtaining at least one PLMN index for at least one entry in the PLMN table from the second message, and wherein the means for determining whether the second cell is accessible by the UE comprises
means for determining at least one PLMN supported by the second cell based on the PLMN table and the at least one PLMN index, and
means for determining whether the second cell is accessible by the UE based on the at least one PLMN supported by the second cell and at least one PLMN permitted for the UE.

21. The apparatus of claim 18, wherein the first message comprises a System Information Block (SIB) carrying the table, and wherein the second message comprises a System Information Block Type 1 (SIB1) carrying the at least one index to the table.

22. A computer program product, comprising:
a computer-readable medium comprising:
code for causing at least one computer to receive a first message on a broadcast channel from a first cell,
code for causing the at least one computer to receive a second message on the broadcast channel from a second cell,
code for causing the at least one computer to obtain a table of information used to determine cell accessibility from the first message,
code for causing the at least one computer to obtain at least one index to the table from the second message, and
code for causing the at least one computer to determine whether the second cell is accessible by a user equipment (UE) based on the table and the at least one index to the table.

23. A method for wireless communication, comprising:
generating a first message comprising a table of information used to determine cell accessibility;
generating a second message comprising at least one index to the table;
sending the first message on a broadcast channel from a cell; and
sending the second message on the broadcast channel from the cell to user equipments (UEs) in neighbor cells, the at least one index in the second message being used by the UEs in the neighbor cells to determine whether the cell is accessible by the UEs.

24. The method of claim 23, wherein the first message comprises a public land mobile network (PLMN) table having multiple entries, each entry being for a different combination of at least one PLMN and associated with a unique profile index, and wherein the second message comprises a profile index for an entry in the PLMN table.

25. The method of claim 23, wherein the first message comprises a public land mobile network (PLMN) table having multiple entries, each entry being for a different PLMN and associated with a unique PLMN index, and wherein the second message comprises at least one PLMN index for at least one entry in the PLMN table.

26. The method of claim 23, wherein the generating the first message comprises generating a System Information Block (SIB) comprising the table and generating the first message with the SIB, and wherein the generating the second message comprises generating a System Information Block Type 1 (SIB1) comprising the at least one index to the table and generating the second message with the SIB1.

27. An apparatus for wireless communication, comprising:
at least one processor configured to generate a first message comprising a table of information used to determine cell accessibility, to generate a second message comprising at least one index to the table, to send the first message on a broadcast channel from a cell, and to send the second message on the broadcast channel from the cell to user equipments (UEs) in neighbor cells, the at least one index in the second message being used by the UEs in the neighbor cells to determine whether the cell is accessible by the UEs.

28. The apparatus of claim 27, wherein the at least one processor is configured to generate the first message comprising a public land mobile network (PLMN) table having multiple entries, each entry being for a different combination of at least one PLMN and associated with a unique profile index, and to generate the second message comprising a profile index for an entry in the PLMN table.

29. The apparatus of claim 27, wherein the at least one processor is configured to generate the first message comprising a public land mobile network (PLMN) table having multiple entries, each entry being for a different PLMN and associated with a unique PLMN index, and to generate the second message comprising at least one PLMN index for at least one entry in the PLMN table.

30. The apparatus of claim 27, wherein the at least one processor is configured to generate a System Information Block (SIB) comprising the table, to generate a System Information Block Type 1 (SIB1) comprising the at least one index to the table, to generate the first message with the SIB, and to generate the second message with the SIB1.
